(19) United States
(12) Patent Application Publication
(10) Pub. No.: US 2026/0035182 A1
(43) Pub. Date: Feb. 5, 2026

(54) CONVEYOR DEVICE

(71) Applicant: NAKANISHI METAL WORKS CO., LTD., Osaka-shi (JP)

(72) Inventor: Yoshihiro OKAZAKI, Osaka-shi (JP)

(73) Assignee: NAKANISHI METAL WORKS CO., LTD., Osaka-shi (JP)

(21) Appl. No.: 19/243,226

(22) Filed: Jun. 19, 2025

(30) Foreign Application Priority Data
Jul. 30, 2024 (JP) 2024-123467

(51) Int. Cl. B65G 35/06; B61B 13/12

(52) U.S. Cl. CPC B65G 35/06; B61B 13/127

(57) ABSTRACT

Provided is a conveyor device including a friction roller type driving device for catch-up, a guide unit that supports the friction roller type driving device to be movable along a conveyance direction of a carriage, and a biasing unit that applies a biasing force to the for biasing the friction roller type driving device to bias it in a downstream direction, the friction roller type driving device moving in the upstream direction against the biasing force by a force in the upstream direction acting on the friction roller type driving device when a following carriage separated from a rear end carriage of a conveyance line in the upstream direction catches up with the rear end carriage. The biasing unit includes a spring that is a generation source of the biasing force, and a biasing force adjustment mechanism that adjusts the biasing force and maintains the magnitude of the biasing force substantially constant.

### FIELD

The present invention relates to a conveyor device that includes a friction roller type driving device for catch-up, and supplies, to a conveyance line, a following carriage separated from a rear end carriage in an upstream direction in the conveyance line.

### BACKGROUND

There is a conveyor device that includes a friction roller type driving device for catch-up, conveys a following carriage separated from a rear end carriage in an upstream direction in a conveyance line at a speed faster than a conveyance speed, and supplies the following carriage to the conveyance line in the conveyance line in which a plurality of non-self-propelled carriages connected by a coupler or a plurality of non-self-propelled carriages compressed without using a coupler are continuously conveyed at a constant conveyance speed by a carriage driving device.

In the conveyor device, it is generally configured to detect that the following carriage catches up with the rear end carriage by detecting increase in a burden imposed to a driving device of the following carriage (for example, detect a motor current of the friction roller type driving device), and to control the speed of the following carriage to be the conveyance speed (for example, paragraph [0002] of Patent Literature 1 (PTL 1)).

In the conveyor device having the above configuration, when the following carriage catches up with the rear end carriage, slippage occurs between a friction roller of the friction roller type driving device and the following carriage. This causes a problem that wear of the friction roller is accelerated. In addition, in a state where slippage occurs between the friction roller and the following carriage, a burden is imposed to a speed reducer of the friction roller type driving device, causing durability of the speed reducer to decrease (for example, paragraph [0005] of Patent Literature (PTL) 1).

In order to solve the above problem, the invention described in PTL 1 includes a guide unit that supports a friction roller type driving device for catch-up to be movable along a conveyance direction of a carriage, and a biasing unit that biases the friction roller type driving device in a downstream direction. Then, the following carriage separated from the rear end carriage in the upstream direction in the conveyance line in which continuous conveyance is performed at a constant conveyance speed by the carriage driving device is conveyed by the friction roller type driving device. When the following carriage catches up with the rear end carriage, the friction roller type driving device moves in the upstream direction against the biasing force of the biasing unit, due to a force in the upstream direction acting on the friction roller type driving device (for example, paragraph [0008] of PTL 1).

### CITATION LIST

### Patent Literature

PTL 1: Japanese Unexamined Patent Application Publication No. 2007-161428

### SUMMARY

### Technical Problem

The conveyor device of PTL 1 uses an air cylinder (for example, an air cylinder 12 in FIGS. 3 and 5) as an example of the biasing unit. A generation source of the biasing force of the biasing unit is air pressure. Accordingly, when the air cylinder is used, the pressure on the secondary side can be maintained substantially constant by a relief mechanism. Therefore, the biasing force (thrust in the downstream direction) of the biasing unit, which is received when the friction roller type driving device moves in the upstream direction, can be maintained substantially constant. As a result, slippage hardly occurs between the friction roller of the friction roller type driving device and the following carriage, so that wear of the friction roller can be reduced.

However, in a case where an air cylinder is used as the biasing unit, an air pressure generation device such as an air compressor, a relief type regulator, an air pipe, and the like are required, and the man-hour of piping work is increased, thereby increasing the cost. In addition, it is not possible to achieve energy saving by eliminating an air compressor that consumes large power and to establish a so-called airless system by which a large amount of CO₂ emission can be reduced, in view of promotion of carbon neutral for greenhouse gas reduction.

Meanwhile, PTL 1 discloses that a compression coil spring or the like may be used as the biasing unit (paragraph of [0028] PTL 1). In a case where a spring such as a compression coil spring is used as the biasing unit, it is possible to establish the airless system.

However, in a case where a spring is used as the biasing unit, increase in the deformation amount of the spring increases the restoring force of the spring. Accordingly, the biasing force (thrust in the downstream direction) of the biasing unit received when the friction roller type driving device moves in the upstream direction cannot be maintained substantially constant. As a result, slippage occurs between a friction roller of the friction roller type driving device and a drive surface of the following carriage that catches up with the rear end carriage, the drive surface being driven by the friction roller. Thus, wear of the friction roller is accelerated.

An object of the present invention is to provide a conveyor device including a friction roller type driving device for catch-up, a guide unit that supports the friction roller type driving device so as to be movable along a conveyance direction of a carriage, and a biasing unit that biases the friction roller type driving device in a downstream direction. In the conveyor device, wear of a friction roller of the friction roller type driving device is not accelerated even if a generation source of a biasing force of the biasing unit is a spring.

### Solution to Problem

A conveyor device according to a first aspect of the present invention is for use in a conveyance line in which a carriage driving device continuously conveys a series of carriages at a constant conveyance speed. The conveyor device includes: a friction roller type driving device including a friction roller that is rotationally driven and pressed against a drive surface of a following carriage separated in an upstream direction from a rear end carriage in the conveyance line, the friction roller type driving device conveying the following carriage at a speed higher than the conveyance speed to supply the following carriage to the conveyance line; a guide unit that supports the friction roller type driving device to be movable along a conveyance direction of a carriage; and a biasing unit that applies a biasing force to the friction roller type driving device to bias the friction roller type driving device in a downstream direction, the friction roller type driving device moving in an upstream direction against the biasing force by a force in the upstream direction acting on the friction roller type driving device when the following carriage catches up with the rear end carriage, and the biasing unit including a spring that is a generation source of the biasing force, and a biasing force adjustment mechanism that adjusts the biasing force and maintains a magnitude of the biasing force substantially constant.

In a conveyor device according to a second aspect of the present invention, in the conveyor device according to the first aspect, the biasing force adjustment mechanism includes a first member and a second member. One of the first member and the second member is a fixed-side member that does not move together with the friction roller type driving device, and a remaining one of the first member and the second member is a moving-side member that moves together with the friction roller type driving device. A restoring force of the spring acts on one of the fixed-side member and the moving-side member, and the restoring force is transmitted to a remaining one of the fixed-side member and the moving-side member.

In a conveyor device according to a third aspect of the present invention, in the conveyor device according to the second aspect, one of the fixed-side member and the moving-side member includes a swing arm that swings about a first horizontal axis orthogonal to the conveyance direction, and a roller that is attached to a free end of the swing arm and is rotatable about a second horizontal axis parallel to the first horizontal axis. A remaining one of the fixed-side member and the moving-side member includes a roller abutment body having a curved surface that is in contact with the roller and is displaced in a vertical direction toward the conveyance direction. The restoring force of the spring acts on the swing arm to press the roller against the curved surface of the roller abutment body.

In a conveyor device according to a fourth aspect of the present invention, in the conveyor device according to any one of the first to third aspects, the spring is placed on a fixed side that does not move together with the friction roller type driving device.

In a conveyor device according to a fifth aspect of the present invention, in the conveyor device according to any one of the first to third aspects, the spring is a compression coil spring, and includes a restriction unit that causes the compression coil spring to deform along a center line of the coil when the compression coil spring contracts.

In a conveyor device according to a sixth aspect of the present invention, in the conveyor device according to any one of the first to third aspects, the spring is a tension coil spring.

In a conveyor device according to a seventh aspect of the present invention, in the conveyor device according to the first aspect, peripheral members of a conveying rail that guides the carriage along a conveying path are placed to sandwich the friction roller type driving device and the guide unit from front and rear sides in the conveyance direction.

In a conveyor device according to an eighth aspect of the present invention, in the conveyor device according to the first aspect, the guide unit includes: a rail member that extends in the conveyance direction and is placed on a fixed side that does not move together with the friction roller type driving device; and a guide roller rotatable along the rail member placed on a moving side that moves together with the friction roller type driving device.

### Advantageous Effects

According to the conveyor device of the present invention, a spring is a generation source of the biasing force that biases the friction roller type driving device for the catch-up in the downstream direction. Therefore, it is possible to realize energy saving by eliminating an air compressor that consumes large power, and to establish a so-called airless system by which a large amount of CO₂ emission can be reduced in view of the promotion of carbon neutral for greenhouse gas reduction.

According to the conveyor device of the present invention, the biasing unit that applies the biasing force (the thrust in the downstream direction) to the friction roller type driving device for the catch-up includes the spring and a biasing force adjustment mechanism that adjusts the biasing force and maintains the magnitude of the biasing force substantially constant. Accordingly, even in a case where the generation source of the biasing force of the biasing unit is a spring, the biasing force adjustment mechanism can maintain the biasing force of the biasing unit, which is received when the friction roller type driving device moves in the upstream direction, substantially constant.

Therefore, slippage hardly occurs between the friction roller of the friction roller type driving device and the drive surface of the following carriage, which is driven by the friction roller, thereby preventing wear of the friction roller.

### BRIEF DESCRIPTION OF DRAWINGS

FIG. 1 is a perspective view around a friction roller type driving device for catch-up in a conveyor device according to an embodiment of the present invention;

FIG. 2 is a perspective view of a state in which a following carriage separated from a rear end carriage in an upstream direction in a conveyance line is driven by the friction roller type driving device, and the friction roller type driving device is moved in the upstream direction by a force in the upstream direction acting on the friction roller type driving device when the following carriage catches up with the rear end carriage. In FIG. 2, a carriage is omitted;

FIG. 3 is a front view of an enlarged main part of FIG. 1;

FIG. 4 is a front view of an enlarged main part of FIG. 2;

FIG. 5 is a plan view of a main part around the friction roller type driving device shown in FIG. 1;

FIG. 6 is a cross-sectional view taken along the line X1-X1 of FIG. 5;

FIG. 7 is a cross-sectional view showing the state of FIG. 2, in a same manner as in

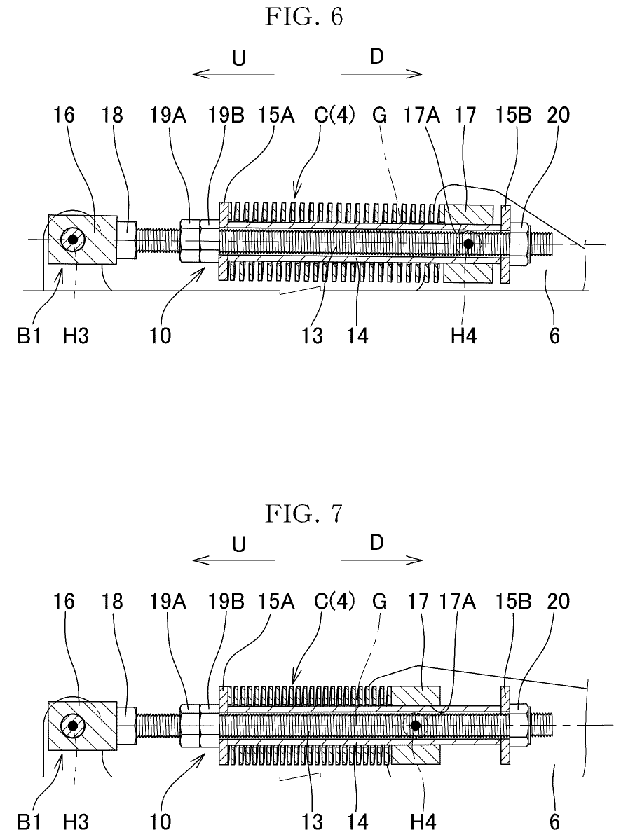

FIG. 6;

FIG. 8 is a cross-sectional view taken along the line Z-Z in FIG. 3;

FIG. 9 is a front view for illustrating a method of adjusting the biasing force by a biasing force adjustment mechanism, and showing a moment at which the following carriage driven by the friction roller type driving device catches up with the rear end carriage of the conveyance line, i.e., a state in which the friction roller type driving device is not moving in the upstream direction (X=0). In FIG. 9, a carriage is omitted;

FIG. 10 is a front view for illustrating a method of adjusting the biasing force by the biasing force adjustment mechanism, and showing a state in which the friction roller type driving device has moved most in the upstream direction (X=L). In FIG. 10, a carriage is omitted;

FIG. 11 is a graph showing the biasing force (the thrust in the downstream direction) of the biasing unit, which is received when the friction roller type driving device moves in the upstream direction, with a horizontal axis as a position of the friction roller type driving device;

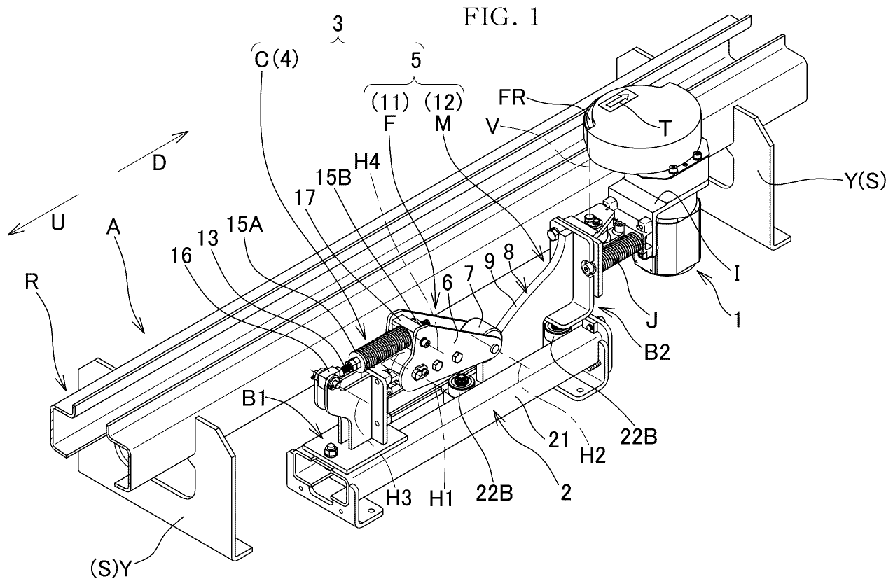

FIG. 12 is a perspective view of a first modification of the biasing unit, and corresponds to FIG. 1;

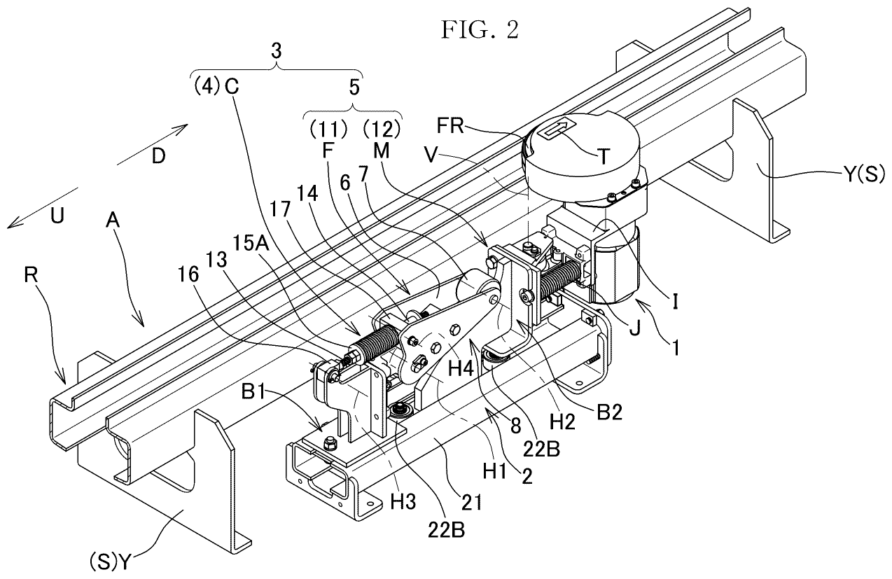

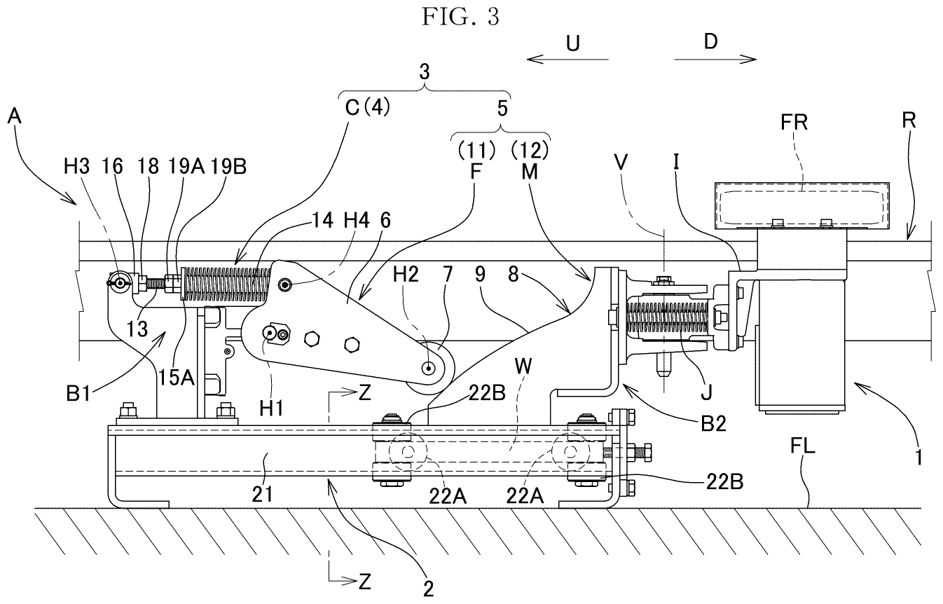

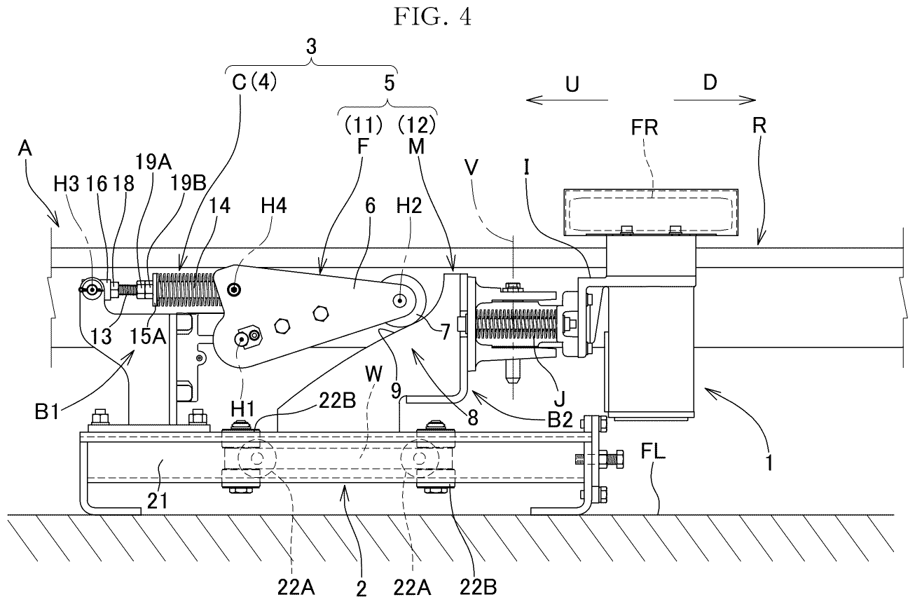

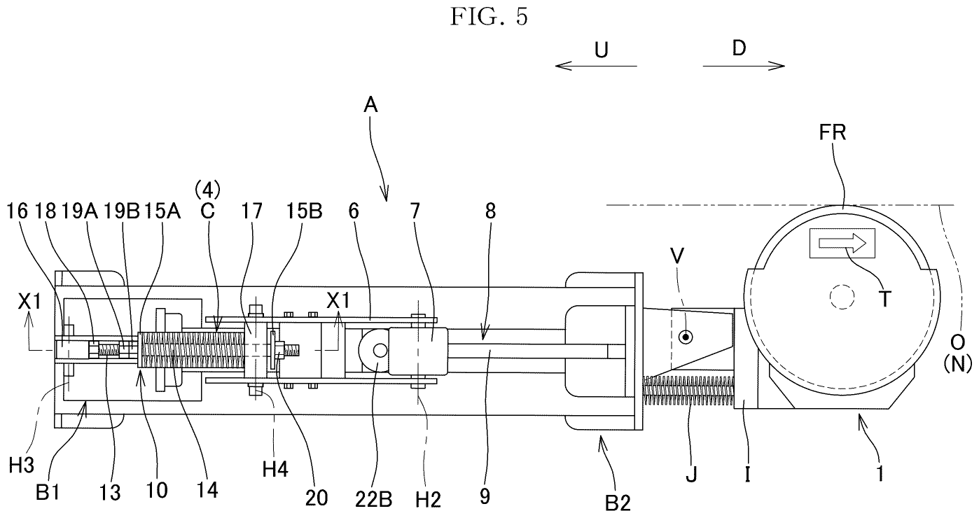

FIG. 13 is a perspective view of the first modification, and corresponds to FIG. 2;

FIG. 14 is a front view of the first modification, and corresponds to FIG. 3;

FIG. 15 is a front view of the first modification, and corresponds to FIG. 4;

FIG. 16 is a perspective view of a second modification of the biasing unit, and corresponds to FIG. 1;

FIG. 17 is a perspective view of the second modification, and corresponds to FIG. 2;

FIG. 18 is a front view of the second modification, and corresponds to FIG. 3; and

FIG. 19 is a front view of the second modification, and corresponds to FIG. 4.

### DESCRIPTION OF EMBODIMENTS

Hereinafter, an embodiment of the present invention will be described with reference to the drawings. Arrows T, D, and U in the drawings indicate a “conveyance direction”, a “downstream direction”, and an “upstream direction”, respectively. Front, rear, left, and right are defined with facing a conveyance direction T (a downstream direction D) of the carriage, and a view viewed from the right is defined as a front view. In the drawings, a fixing member such as an anchor bolt for fixing to a floor FL is omitted.

### [Conveyor Device]

A conveyor device A according to an embodiment of the present invention illustrated in FIGS. 1 to 5 conveys a plurality of non-self-propelled carriages along a loop-shaped conveyance line illustrated in a layout diagram of FIG. 1 of PTL 1, for example. A conveyance line (L1, L2) in the layout diagram of FIG. 1 of PTL 1 is, for example, a conveyance line for continuously conveying a series of carriages at a constant conveyance speed by a carriage driving device that is, for example, a friction roller type driving device. In the conveyance line, the carriages are coupled by a coupler or compressed without using a coupler. The plurality of non-self-propelled carriages in the conveyor device A according to the embodiment of the present invention move, for example, along a conveyance rail R partially illustrated in FIGS. 1 to 4. The carriage driving device that continuously conveys the series of carriages may be a chain type driving device or the like that tows the carriages by a drive chain.

The conveyor device A includes a friction roller type driving device 1 for catch-up, which presses a friction roller FR that is rotationally driven against a drive surface O (FIG. 5) of a following carriage N separated from a rear end carriage in the conveyance line in an upstream direction U, conveys the following carriage N at a speed higher than the conveyance speed, and supplies the following carriage N to the conveyance line.

The friction roller type driving device 1 is supported by a bracket I that swings about a vertical axis V with respect to a moving base B2. In a state where the friction roller FR of the friction roller type driving device 1 is in contact with the drive surface O of the following carriage N, a compression coil spring J between the moving base B2 and the bracket I is compressed. Therefore, the friction roller FR is pressed against the drive surface O by the restoring force of the compression coil spring J.

### [Guide Unit]

As illustrated in FIGS. 1 to 4 and 8, the conveyor device A includes a guide unit 2 that supports the friction roller type driving device 1 so as to be movable along the conveyance direction T along which the carriage is conveyed. The guide unit 2 includes a rail member 21 that extends in the conveyance direction T and is arranged on a fixed side that does not move together with the friction roller type driving device 1, and guide rollers 22A and 22B that are arranged on a moving side that moves together with the friction roller type driving device 1, and are rotatable along the rail member 21.

As illustrated in FIG. 8, left and right rail members 21 and 21 have U-shaped cross sections with openings facing each other, and each have an upper flange portion 21A and a lower flange portion 21B extending in the horizontal direction. As illustrated in FIGS. 3, 4, and 8, vertical guide rollers 22A are arranged on the left and right of a support body W at front and rear side thereof, and horizontal guide rollers 22B on the top and bottom of the support boy W at front and rear side thereof. Each vertical guide roller 22A is located between the upper flange portion 21A and the lower flange portion 21B and rolls on the lower flange portion 21B. Each horizontal guide roller 22B is located between the left and right upper flanges 21A and 21A and between the left and right lower flanges 21B and 21B.

The guide unit 2 includes the rail members 21 and the guide rollers 22A and 22B rotatable along the rail member 21, thereby reducing the manufacturing cost. In addition, since there is no item that requires long time to be delivered after placing an order, the maintenance can be easily performed, thereby increasing the operating rate.

### [Biasing Unit]

As shown in FIGS. 1 to 4, the conveyor device A includes a biasing unit 3 that applies a biasing force to the friction roller type driving device 1 to bias the friction roller type driving device 1 in the downstream direction D.

The friction roller type driving device 1 moves in the upstream direction U against the biasing force of the biasing unit 3 by the force acting on the friction roller type driving device 1 in the upstream direction U when the following carriage N catches up with the rear end carriage in the conveyance line.

The biasing unit 3 includes a compression coil spring C that is a spring 4 as a generation source of the biasing force, and a biasing force adjustment mechanism 5 that adjusts the biasing force and maintains the magnitude of the biasing force substantially constant. The direction along which the compression coil spring C contracts is a direction substantially parallel to the conveyance direction T.

### [Biasing Force Adjustment Mechanism]

As illustrated in FIGS. 1 to 4, the biasing force adjustment mechanism 5 includes a first member 11 and a second member 12. The first member 11 is a fixed-side member F that does not move together with the friction roller type driving device 1. The second member 12 is a moving-side member M that moves together with the friction roller type driving device 1. The restoring force of the compression coil spring C acts on the fixed-side member F, and the restoring force is transmitted to the moving-side member M.

The fixed-side member F includes a swing arm 6 that swings around a horizontal axis H1 orthogonal to the conveyance direction T, and a roller 7 that is attached to a free end of the swing arm 6 and is rotatable around a horizontal axis H2 parallel to the horizontal axis H1. The moving-side member M includes a roller abutment body 8 having a curved surface 9 that is in contact with the roller 7 and is displaced in the vertical direction toward the conveyance direction T. The restoring force of the compression coil spring C acts on the swing arm 6 so as to press the roller 7 against the curved surface 9 of the roller abutment body 8.

[Restriction Unit that Causes the Compression Coil Spring to Deform Along the Center Line of the Coil when the Compression Coil Spring Contracts]

The compression coil spring C, which is a generation source of the biasing force, is compressed to generate a restoring force. Therefore, in order to reduce the variation in the restoring force based on the deformation amount when the compression coil spring C is compressed, it is necessary to prevent the compression coil spring C from deforming in the orthogonal direction by preventing the force in the direction orthogonal to a center line G of the coil from acting when the compression coil spring C is compressed. Therefore, there is provided a restriction unit 10 that is shown in FIGS. 5 to 7 and causes the compression coil spring C to deform along the center line G of the coil when the compression coil spring C contracts. This reduces the variation in the spring force K corresponding to the restoring force, and as a result, the biasing force P can be made constant (from later-described formulas (1) and (2)).

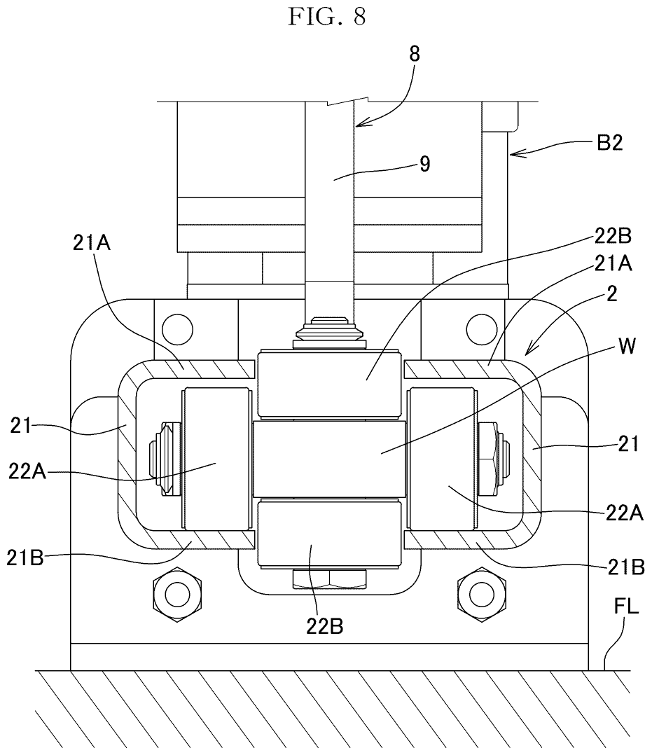

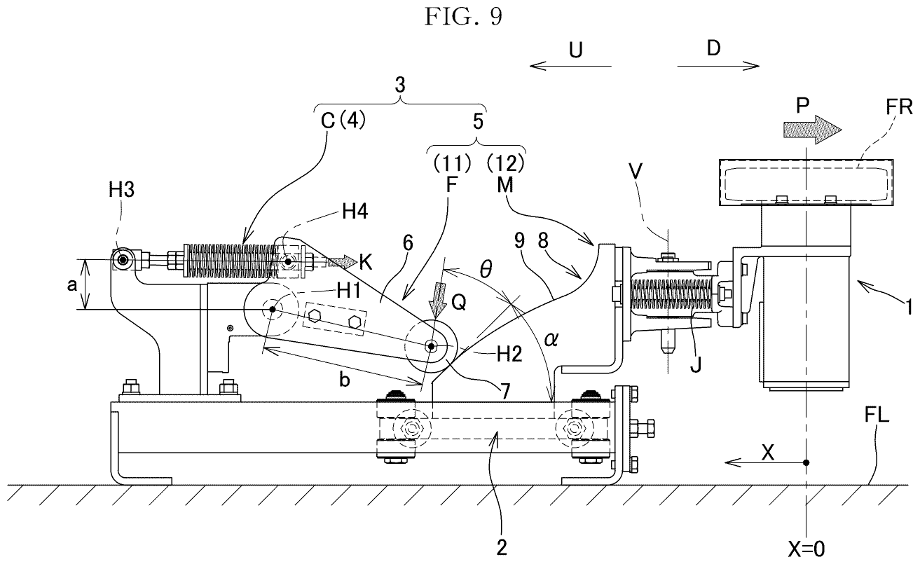

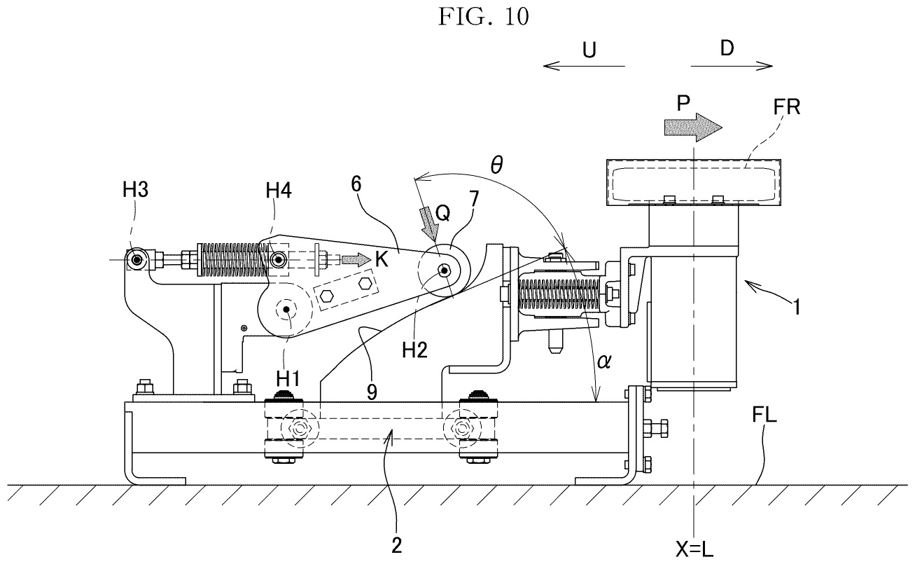

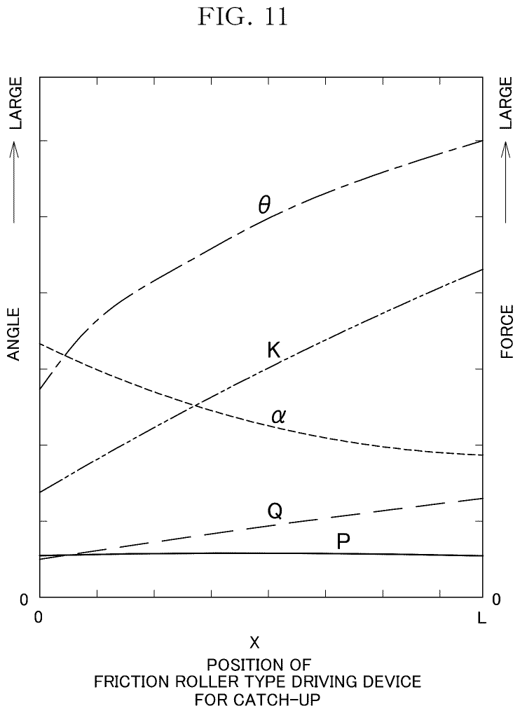

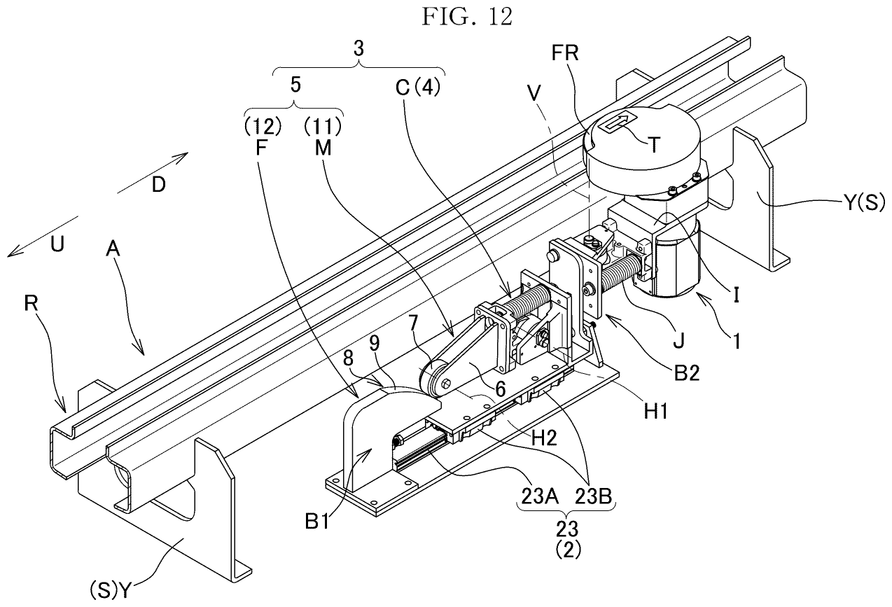

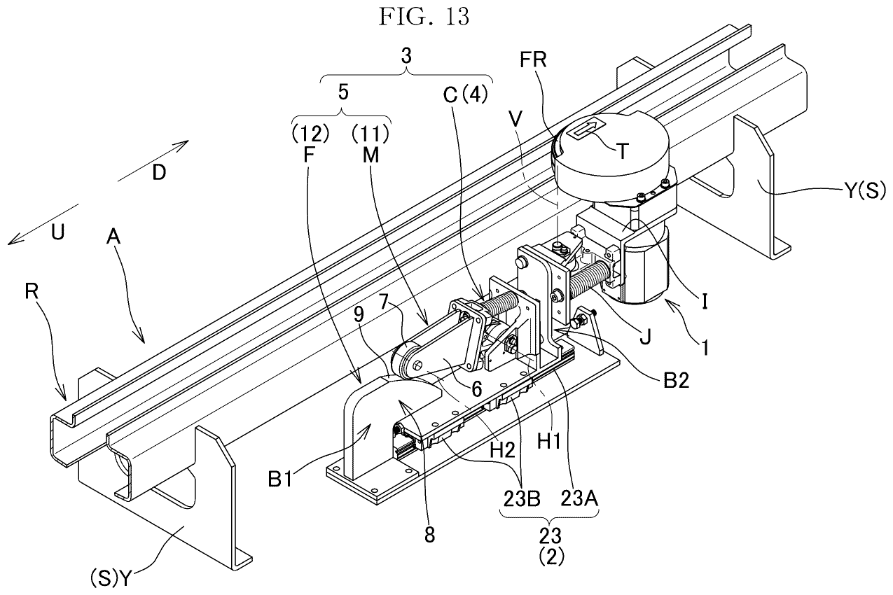

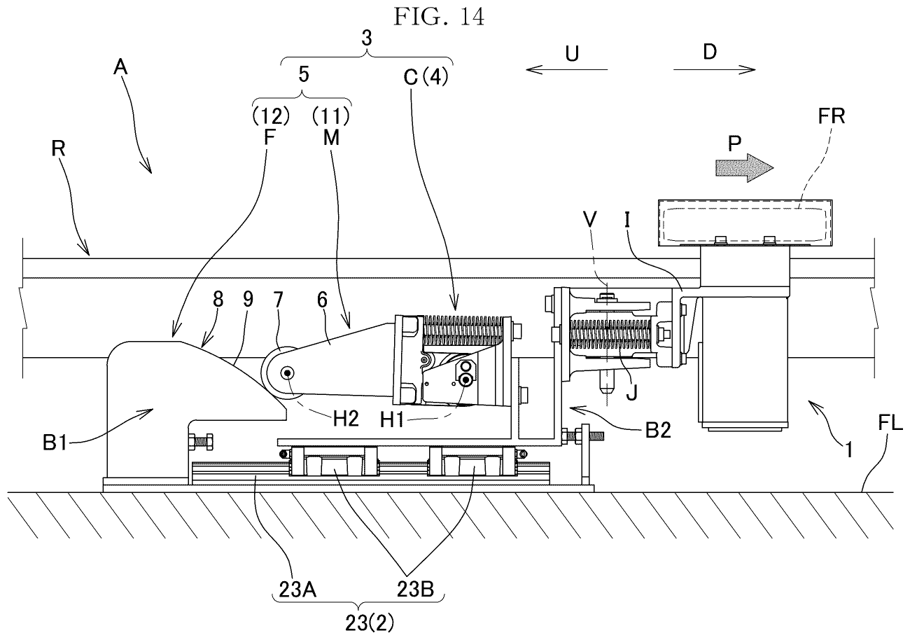

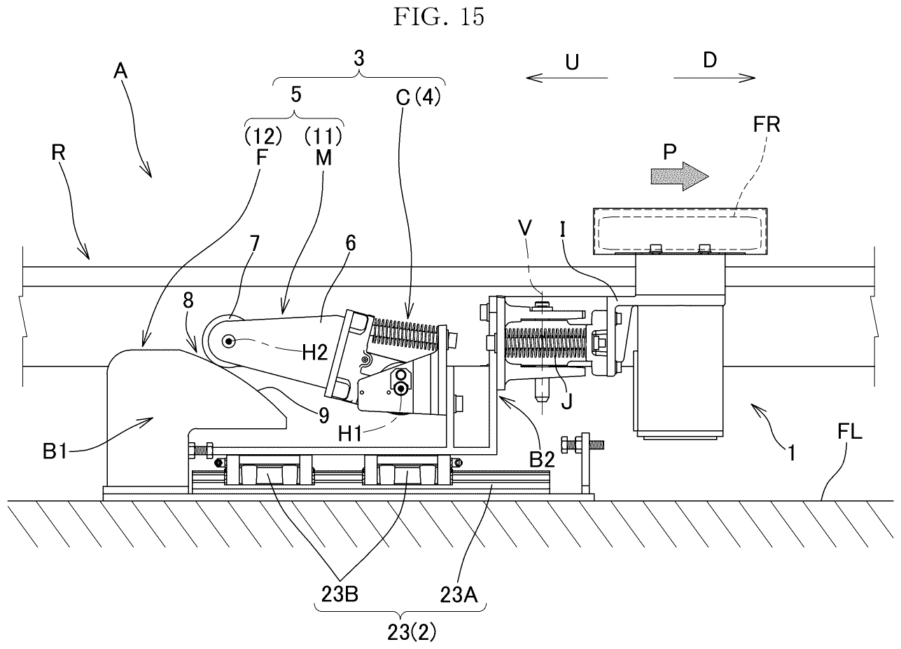

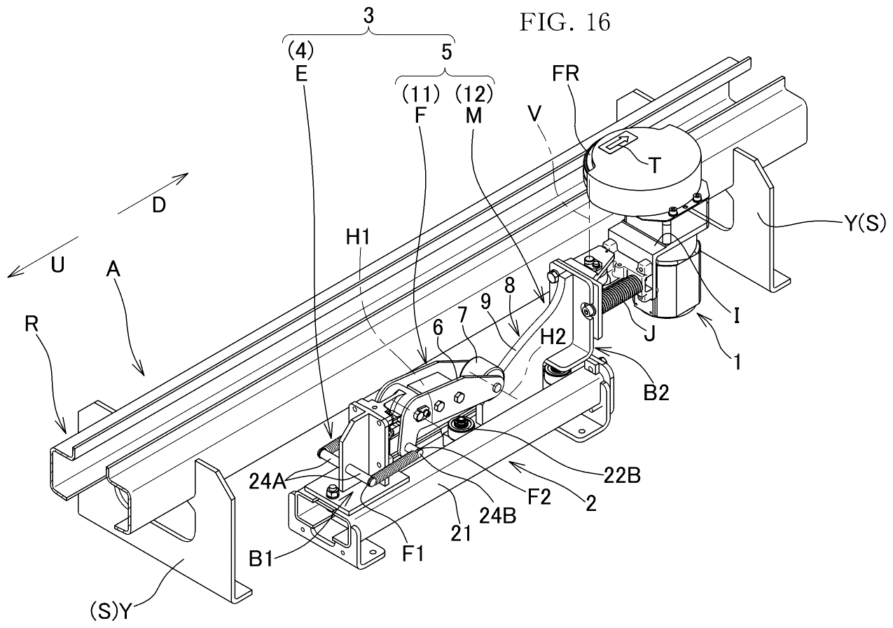

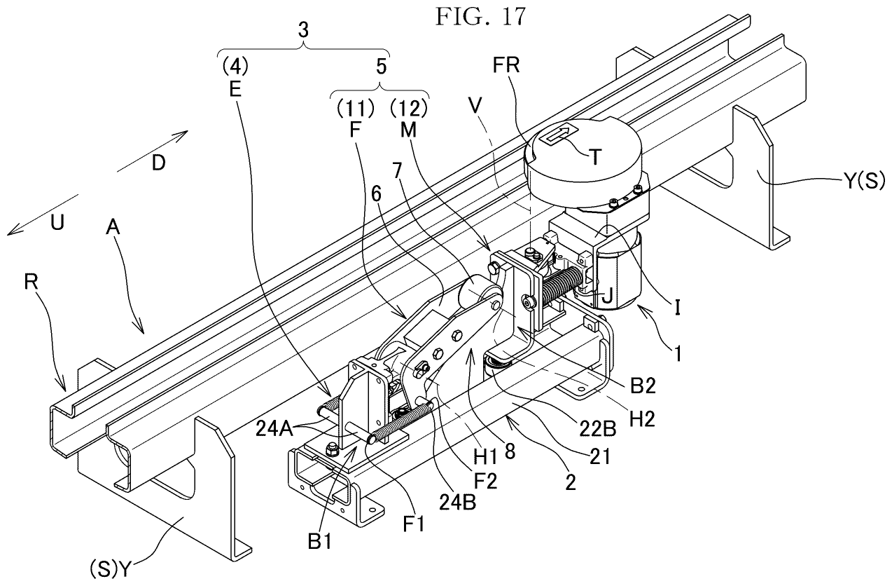

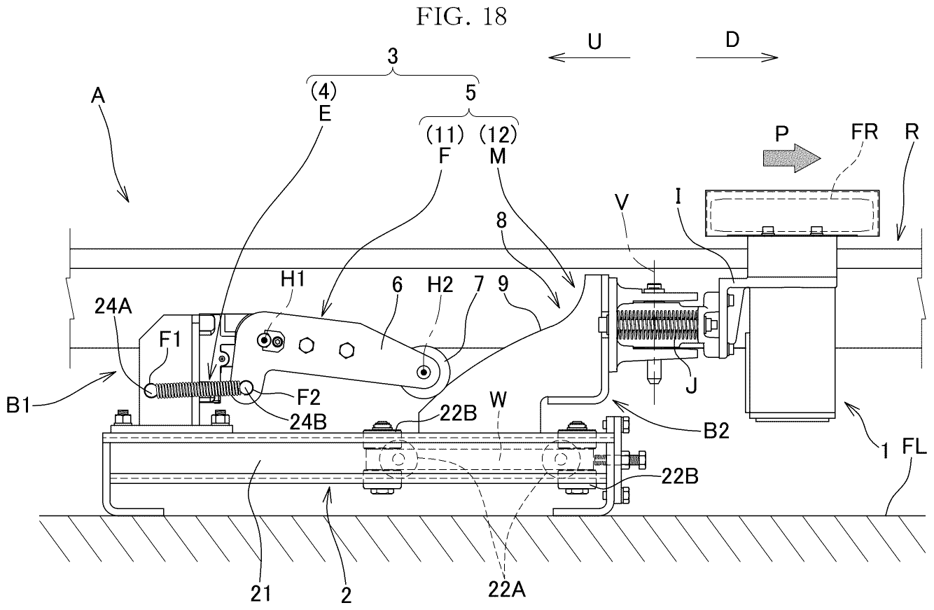

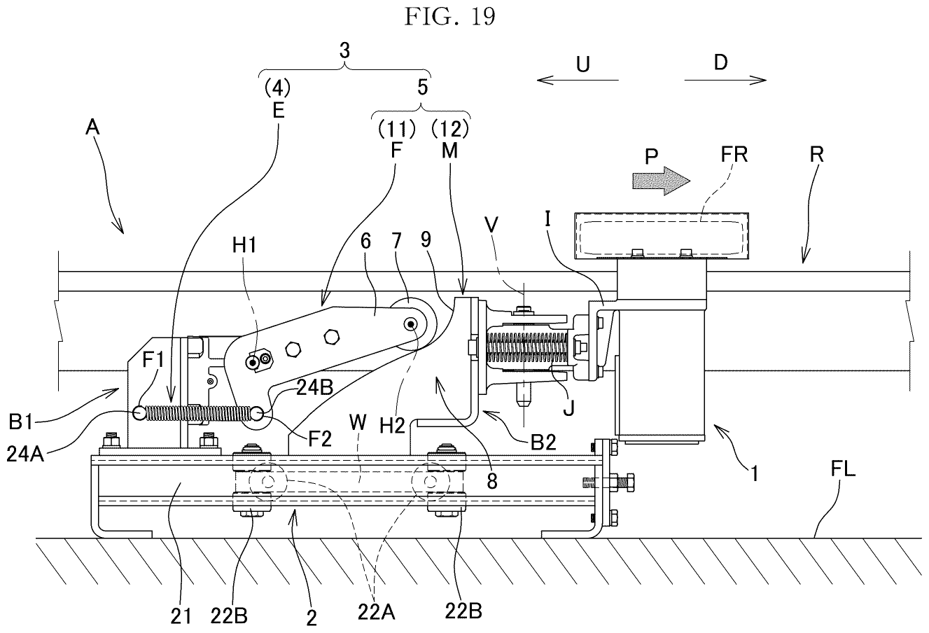

The configuration and operation of the restriction unit 10 will be described with reference to FIGS. 6 and 7. The restriction unit 10 includes a screw shaft 13, a guide cylindrical body 14, flange bodies 15A and 15B, swinging bodies 16 and 17, and nuts 18,19A, 19B, and 20.

The swing body 16 located in an upstream direction U side of the compression coil spring C is supported o be swingable about a horizontal axis H3 of a fixed base B1, which is parallel to the horizontal axis H1 (FIG. 3) that is the swing center of the swing arm 6. The swing body 17 located in a downstream direction D side of the compression coil spring C above the horizontal axis H1 of the swing arm 6 and is supported to be swingable about a horizontal axis H4 of the swing arm 6, which is parallel to the horizontal axis H1.

The screw shaft 13 is inserted into the flange body 15A and the guide cylindrical body 14, and the guide cylindrical body 14 is inserted into the coil of the compression coil spring C. The nuts 19B, 19A, and 18 are screwed to the upstream direction U side of the screw shaft 13, the downstream direction D side of the guide cylindrical body 14 is inserted into a through hole 17A of the swing body 17, the flange body 15B is inserted into an end portion of the screw shaft 13 in the downstream direction D, and the nut 20 is screwed. An end portion of the screw shaft 13 in the upstream direction U is fixed to the swing body 16 by the nut 18.

Positions of the nuts 19B and 20 to be screwed to the screw shaft 13 are adjusted and positioned so that the flange bodies 15A and 15B sandwiching the guide cylindrical body 14 at its opposite end surfaces are located at predetermined positions with respect to the screw shaft 13. In this state, the guide cylindrical body is fixed to the nut 19B by the nut 19A that is a double nut with the nut 19B.

In this state, the end surface of the compression coil spring C on the upstream direction U side is in contact with the side surface of the flange body 15A in the downstream direction D, and the end surface of the compression coil spring C on the downstream direction D side is in contact with the side surface of the swing body 17 in the upstream direction U. As shown in FIGS. 6 to 7, when the compression coil spring C contracts, the compression coil spring C is deformed along the center line G of the coil.

### [Arrangement of Spring]

In the examples of FIGS. 1 to 4, the spring 4 is placed on the fixed side that does not move together with the friction roller type driving device 1. Accordingly, the spring 4 and its peripheral components, and the swing arm 6 and the roller 7 in the biasing force adjustment mechanism 5 are also located on the fixed side. Therefore, the weight of the moving side can be reduced, thereby making the movement of the friction roller type driving device 1 along the guide unit 2 smoother. In addition, the wear amount of the roller 7 can be reduced.

### [Description of Method of Adjusting Biasing Force by Biasing Force Adjustment Mechanism]

The specifications shown in FIGS. 9 and 10 are used. FIG. 9 shows a moment when the following carriage N (FIG. 5) driven by the friction roller type driving device 1 catches up with the rear end carriage in the conveyance line, and a coordinate in a direction along which the friction roller type driving device 1 moves in the upstream direction U is set as X. The position of the friction roller type driving device 1 in the X-coordinate in FIG. 9 is X=0.

The position of the friction roller type driving device 1 in the X-coordinate in a state where the friction roller type driving device shown in FIG. 10 has moved most in the upstream direction U is defined as X=L.

A roller pressing force Q shown in FIGS. 9 and 10 is obtained by an equation (1) where a and b in FIG. 9 are used and the spring force is K.

Q=(a/b)·K (1)

When a contact angle θ and an inclination angle α are adopted as shown in FIGS. 9 and 10, the biasing force (thrust in the downstream direction D) P for the biasing unit 3 to bias the friction roller type driving device 1 in the downstream direction D is obtained by an equation (2).

P=(sin α/sin θ)·Q (2)

Specifically, the roller pressing force Q that varies depending on the position of the X-coordinate of the friction roller type driving device 1 is adjusted with (sin α/sin θ) that varies depending on the position of the X-coordinate, thereby making the biasing force P be substantially constant. In order to realize the substantially constant biasing force P in this manner, the shape of the curved surface 9 of the roller abutment body 8 on which the roller 7 abuts is gradually changed, and the contact angle θ and the inclination angle α are gradually changed so that sin θ and sin α have required magnitudes depending on the position of the X-coordinate.

FIG. 11 is a graph showing the biasing force P (solid line) of the biasing unit 3 together with the contact angle θ, the inclination angle α, the spring force K, and the roller pressing force Q with the horizontal axis showing the position of the friction roller type driving device 1 in the X-coordinate.

It can be seen from FIG. 11 that the magnitude of the biasing force P of the biasing unit 3 can be maintained substantially constant by the biasing force adjustment mechanism 5 regardless of the position of the friction roller type driving device 1 in the X-coordinate.

### [Restriction by Arrangement of Rail Peripheral Members]

In order to form the biasing unit 3 only with the spring 4 without using the biasing force adjustment mechanism 5 and to obtain a required biasing force while reducing the fluctuation in the magnitude of the biasing force of the biasing unit 3, a spring having a very long free length needs to be used as the spring 4, for example.

However, rail peripheral members S such as a rail support member Y, a cable support member, and a power supply device, or the like in FIGS. 1 and 2 are disposed around the conveyance rail R, and the rail peripheral members S become an obstacle. Therefore, it is difficult to arrange the coil spring having a very long free length in the upstream direction U of the friction roller type driving device 1. Therefore, the biasing unit 3 including only the spring 4 that reduces the variation in the magnitude of the biasing force of the biasing unit 3 is not realistic. Even if the coil spring having a very long free length can be arranged, the magnitude of the biasing force of the biasing unit 3 cannot be maintained substantially constant.

On the other hand, in the present embodiment, the compression coil spring C having a relatively short free length is used as the spring 4, and the biasing force is adjusted using the biasing force adjustment mechanism 5, for example as shown in FIGS. 1 and 2. Therefore, in the present embodiment, the friction roller type driving device 1, the guide unit 2, and the like are easily disposed even if there is the rail peripheral member S. As shown in FIGS. 1 and 2, for example, the rail support member Y, which is the rail peripheral member S, can be disposed so as to sandwich the friction roller type driving device 1 and the guide unit 2 from the front and the rear in the conveyance direction T. Then, the biasing force of the biasing unit 3 can be adjusted using the biasing force adjustment mechanism 5 to maintain the magnitude of the biasing force substantially constant.

### [First Modification of Biasing Unit]

A first modification of the biasing unit 3 is shown in FIGS. 12 to 15. In the first modification, unlike the examples of FIGS. 1 to 4, the compression coil spring C, which is the spring 4 as a generation source of the biasing force of the biasing unit 3, the swing arm 6, and the like move together with the friction roller type driving device 1, and the roller abutment body 8 does not move together with the friction roller type driving device 1.

### [Biasing Force Adjustment Mechanism]

In the first modification, the first member 11 of the biasing force adjustment mechanism 5 is a moving-side member M that moves together with the friction roller type driving device 1, and the second member 12 of the biasing force adjustment mechanism 5 is a fixed-side member F that does not move together with the friction roller type driving device 1. The restoring force of the compression coil spring C acts on the moving-side member M, and the restoring force is transmitted to the fixed-side member F.

The moving-side member M includes the swing arm 6 that swings around the horizontal axis H1 orthogonal to the conveyance direction T, and the roller 7 that is attached to the free end of the swing arm 6 and is rotatable around the horizontal axis H2 parallel to the horizontal axis H1. The fixed-side member F includes the roller abutment body 8 having the curved surface 9 that is in contact with the roller 7 and is displaced in the vertical direction toward the conveyance direction T. The restoring force of the compression coil spring C acts on the swing arm 6 so as to press the roller 7 against the curved surface 9 of the roller abutment body 8. The direction in which the compression coil spring C contracts is substantially parallel to the conveyance direction T.

Similarly to the examples of FIGS. 1 to 4, the biasing force adjustment mechanism 5 in the first modification can maintain the biasing force P in which the biasing unit 3 biases the friction roller type driving device 1 in the downstream direction D as shown in FIGS. 14 and 15 substantially constant.

### [Guide Unit]

In the examples of FIGS. 12 to 15, the guide unit 2 that supports the friction roller type driving device 1 to be movable along the conveyance direction T of the carriage is a linear guide 23 including a guide rail 23A and a guide block 23B that moves along the guide rail. The linear guide 23 is used as the guide unit 2, thereby simplifying the structure.

### [Second Modification of Biasing Unit]

A second modification of the biasing unit 3 is shown in FIGS. 16 to 19. In the second modification, the spring 4 as a generation source of the biasing force of the biasing unit 3 is a tension coil spring E, unlike the examples of FIGS. 1 to 4. The direction in which the tension coil spring E extends is substantially parallel to the conveyance direction T.

The tension coil spring E is used as the spring 4, and the hooks F1 and F2 at both ends of the tension coil spring E are respectively hooked on hooking protrusions 24A and 24B, whereby the attachment is completed. The tension coil spring E deforms along the center line of the coil when the tension coil spring E extends, thereby simplifying the structure around the tension coil spring E.

In the present invention, the spring 4 that is a generation source of the biasing force of the biasing unit 3 is not limited to the compression coil spring C or the tension coil spring E. The spring 4 may be a torsion spring, a torsion coil spring, a spiral spring, a leaf spring, or the like.

### [Biasing Force Adjustment Mechanism]

A first member 11 of the biasing force adjustment mechanism 5 in the second modification is similar to the examples of FIGS. 1 to 4, and is the fixed-side member F that does not move together with the friction roller type driving device 1. A second member 12 of the biasing force adjustment mechanism 5 in the second modification is similar to the examples of FIGS. 1 to 4, and is the moving-side member M that moves together with the friction roller type driving device 1. Therefore, similarly to the examples of FIGS. 1 to 4, the restoring force of the tension coil spring E acts on the first member 11 that is the fixed-side member F, and the restoring force is transmitted to the second member 12 that is the moving-side member M.

Also in the second modification, similarly to the example of FIGS. 1 to 4, the biasing force adjustment mechanism 5 can maintain the biasing force P substantially constant. By the biasing force P, the biasing unit 3 biases the friction roller type driving device 1 in the downstream direction D as shown in FIGS. 18 and 19.

As described above, the biasing force adjustment mechanism 5 provided in the conveyor device A according to the embodiments of the present invention includes the first member 11 and the second member 12. One of the first member 11 and the second member 12 is the fixed-side member F that does not move together with the friction roller type driving device 1, and the other is the moving-side member M that moves together with the friction roller type driving device 1. A restoring force of the spring 4 acts on one of the fixed-side member F and the moving-side member M, and the restoring force is transmitted to the other of the fixed-side member F and the moving-side member M.

One of the fixed-side member F and the moving-side member M includes a swing arm 6 that swings around the horizontal axis H1 orthogonal to the conveyance direction T of the carriage, and the roller 7 that is attached to a free end of the swing arm 6 and is rotatable around the horizontal axis H2 parallel to the horizontal axis H1. The other of the fixed-side member F and the moving-side member M includes a roller abutment body 8 having the curved surface 9 that is in contact with the roller 7 and is displaced in the vertical direction as it moves in the conveyance direction T. The restoring force of the spring 4 acts on the swing arm 6 so as to press the roller 7 against the curved surface 9 of the roller abutment body 8.

### EFFECTS

In the conveyor device A according to the embodiment of the present invention, the spring 4 is a generation source of the biasing force that biases the friction roller type driving device 1 in the downstream direction D. Therefore, it is possible to realize energy saving by eliminating an air compressor that consumes large power and establish a so-called airless system by which a large amount of CO₂ emission can be reduced in view of carbon neutral.

In the conveyor device A according to the embodiment of the present invention, the biasing unit 3 that applies the biasing force (the thrust in the downstream direction D) P to the friction roller type driving device 1 includes the spring 4 and the biasing force adjustment mechanism 5 that adjusts the biasing force P and maintains the magnitude of the biasing force P substantially constant. Accordingly, even when the generation source of the biasing force P of the biasing unit 3 is the spring 4, the biasing force adjustment mechanism 5 can maintain the biasing force P of the biasing unit 3, which is received when the friction roller type driving device 1 moves in the upstream direction U, substantially constant.

Therefore, slippage hardly occurs between the friction roller FR of the friction roller type driving device 1 and the drive surface O of the following carriage N driven by the friction roller FR, thereby preventing wear of the friction roller FR.

The description of the above embodiment is entirely illustrative, and the present disclosure is not limited thereto. A variety of improvements and alterations can be made without departing from the scope of the present invention.

1. A conveyor device for use in a conveyance line in which a carriage driving device continuously conveys a series of carriages at a constant conveyance speed, the conveyor device comprising:
a friction roller type driving device including a friction roller that is rotationally driven and pressed against a drive surface of a following carriage separated in an upstream direction from a rear end carriage in the conveyance line, the friction roller type driving device conveying the following carriage at a speed higher than the conveyance speed to supply the following carriage to the conveyance line;
a guide unit that supports the friction roller type driving device to be movable along a conveyance direction of a carriage; and
a biasing unit that applies a biasing force to the friction roller type driving device to bias the friction roller type driving device in a downstream direction,
the friction roller type driving device moving in an upstream direction against the biasing force by a force in the upstream direction acting on the friction roller type driving device when the following carriage catches up with the rear end carriage, and
the biasing unit including
a spring that is a generation source of the biasing force, and
a biasing force adjustment mechanism that adjusts the biasing force and maintains a magnitude of the biasing force substantially constant.

2. The conveyor device according to claim 1, wherein
the biasing force adjustment mechanism includes a first member and a second member,
one of the first member and the second member is a fixed-side member that does not move together with the friction roller type driving device,
a remaining one of the first member and the second member is a moving-side member that moves together with the friction roller type driving device,
a restoring force of the spring acts on one of the fixed-side member and the moving-side member, and
the restoring force is transmitted to a remaining one of the fixed-side member and the moving-side member.

3. The conveyor device according to claim 2, wherein
one of the fixed-side member and the moving-side member includes
a swing arm that swings about a first horizontal axis orthogonal to the conveyance direction, and a roller that is attached to a free end of the swing arm and is rotatable about a second horizontal axis parallel to the first horizontal axis,
a remaining one of the fixed-side member and the moving-side member includes
a roller abutment body having a curved surface that is in contact with the roller and is displaced in a vertical direction toward the conveyance direction, and
the restoring force of the spring acts on the swing arm to press the roller against the curved surface of the roller abutment body.

4. The conveyor device according to claim 1, wherein
the spring is placed on a fixed side that does not move together with the friction roller type driving device.

5. The conveyor device according to claim 1, wherein
the spring is a compression coil spring, and includes
a restriction unit that causes the compression coil spring to deform along a center line of the coil when the compression coil spring contracts.

6. The conveyor device according to claim 1, wherein
the spring is a tension coil spring.

7. The conveyor device according to claim 1, wherein
peripheral members of a conveying rail that guides the carriage along a conveying path are placed to sandwich the friction roller type driving device and the guide unit from front and rear sides in the conveyance direction.

8. The conveyor device according to claim 1, wherein
the guide unit includes:
a rail member that extends in the conveyance direction and is placed on a fixed side that does not move together with the friction roller type driving device; and
a guide roller rotatable along the rail member placed on a moving side that moves together with the friction roller type driving device.
